(19) United States
(12) Patent Application Publication
(10) Pub. No.: US 2006/0170395 A1
(43) Pub. Date: Aug. 3, 2006

(54) Tool storage case

(76) Inventors: Chikai Yoshimizu, Ibaraki (JP); Eiji Nakayama, Ibaraki (JP); Hiroyuki Hanawa, Ibaraki (JP); Nobuhiro Takano, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/341,393

(22) Filed: Jan. 30, 2006

(30) Foreign Application Priority Data
Jan. 31, 2005 (JP) P2005-022357

(51) Int. Cl. H02J 7/00

(52) U.S. Cl. 320/114

(57) ABSTRACT

An electric device mounting type tool storage case that is easily transported together with other electric devices such as audio devices in addition to an electric tool body and can stand against contamination such as dust in the work site. An audio device as an electric device can be stored in the tool storage case which is used as an enclosure of a pair of speakers. Storage portions disposed in the tool storage case are partitioned by partition walls into a pair of sound channel spaces. In addition, a power switching circuit of an AC-DC converter power supply circuit or a battery DC power supply is formed in the tool storage case, and power wiring lines or inner wiring lines are disposed along the partition walls. While a cover case closes a storage case, electric devices such as an audio device or a charger are operated.

### BACKGROUND OF THE INVENTION

1. Field of Invention

The present invention relates to a tool storage case that is used to transports an electric tool body such as an impact driver used in a work site such as a construction site, or to stores the electric tool body therein when the electric tool body is unused. Specifically, the invention is related to an electric device mounting type tool storage case that is suitable for transporting other electric devices such as audio devices in addition to the electric tool body required in a work site.

2. Description of Related Art

The audio device as disclosed in this specification has broad meaning including audio electric devices such as an audio amplifier, radio tuners (AM tuner, FM tuner, TV audio tuner), an MD player, a CD player, etc.

In general, when an electric tool is transported to the work site, a storage case for the electric tool is used to conveniently transport the tool body, tip tools to be used for the tool body such as a connection socket and a bit, and auxiliaries related to the tool body such as a battery pack (cassette type accumulator battery) and a charger, simultaneously. The tool storage case is composed of a storage case and a cover case provided at an opening of the storage case so as to open and close the opening, and includes a tool storage portion for storing an electric tool body, a small object storage portion for storing a small object such as a socket, and a battery storage portion for storing a battery pack, which are partitioned in the storage case by the storage partition walls (fixing ribs). The tool storage case is transported with the cover case closed.

When the electric tool is transported to the work site such as a construction site, it is necessary that other electric devices used in the work site, the tool storage case, and electric devices used to improve work efficiency such as an audio device and a lighting device be simultaneously transported to the work site in addition the electric tool stored in the tool storage case. The tool storage case should be packed in a compact manner so as to be easily loaded on a transportation vehicle for the work site, and so as to be transported to the work site, that is, so as to be easily transported to the upper floor in a building.

An audio device such as a portable stereo, an MD player, or a CD player, which is a special electric device to be transported to the work site in addition to the electric tool, is generally transported to the work in order to improve work efficiency by allowing workers to listen to music or talk shows. For example, when one or more workers work in the construction site of a general house or building, they cannot work while talking to each other. Accordingly, there are many cases that the workers transport an audio device such as a stereo or a CD player to the work site so as to work while listening music or talk shows. Listening to music is effective to rhythmically work, to reduce tiredness, or to improve efficiency.

Particularly, audio devices disclosed in U.S. Pat. No. 6,427,070 and a publication US2003/0117107 of have been known as an audio device suitable to be used in the work site. According to the audio devices disclosed in the related arts, audio devices, which can withstand severe conditions in the work site, are provided by offering a protective rod or a protective shield made of a metal pipe around a radio casing, in order to prevent the audio devices from being damaged by an object which may fall on the audio device or by falling themselves. Furthermore, according to the audio devices disclosed in the related arts, a charger for charging a battery pack of the electric tool is mounted in the audio device, and one of power (power supplied from a commercial AC power supply) of the charger and power of the battery pack is used as a power for the radio. That is, the audio devices are integrally formed with an assembly of the charger of the battery pack for the electric tool.

The audio devices used in the work site disclosed in the U.S. Patent Documents have heavy weight and the special shapes. Accordingly, it is difficult to pack the audio devices in a compact manner to transport them together with the electric tool. Furthermore, it is inconvenient to transport the audio devices by a transportation vehicle to the work site, and to carry the audio devices in the work site. For example, when transporting the audio devices to the upper floor in a building, the worker in the building site needs to separately transport a storage case in which a cordless driver drill is stored, and the audio devices. In addition, when other electric devices or working devices are also transported, it takes time and effort to transport the devices over several trips.

Moreover, since there is much noise of other electric tools, construction vehicles, or generators in the work site, it is required that the audio device can be played in a large sound volume and includes a speaker enclosure having high sound quality. Furthermore, in the speaker enclosure, since a speaker unit (hereinafter, the ‘speaker unit’ is simply referred to as a ‘speaker’) generally has a magnet, there has been a problem that iron machining dust or other dust is attached to the magnet, whereby the operation of the speaker is interrupted.

In addition, power condition of the audio device used in the work site should be considered. In the work site to which an AC power supply such as a commercial AC power supply and a generator is provided, AC power is converted into DC power and then the DC power is used. In the work site to which an AC power supply such as a commercial AC power supply and a generator cannot be provided, it is necessary that the accumulator battery having the same shape as a battery pack used in the (cordless type) electric tool be used as a power supply.

Furthermore, since the power cord or the antenna of the audio device extends from the electric device body and is exposed to the outside, and is not stored, the worker may be obstructed by the cord or the antenna, which is exposed to the work site. There is a possibility that the electric device is damaged.

In addition, since the audio device is not used only indoors, the audio device is required to have durability against outdoor dust or rainwater.

### SUMMARY OF INVENTION

Accordingly, it is a main object of the invention to provide a compact electric device mounting type tool storage case that is convenient to be transported by a vehicle or to be carried and stores other electric devices, specifically an audio device therein.

It is another object of the invention to provide an electric device mounting type tool storage case using a tool storage case for storing the electric tool body as a speaker enclosure (speaker box) that is suitable for high quality and large sound volume.

It is still another object of the invention to provide an electric device mounting type tool storage that can protect audio devices or other electric devices from the contaminated environment such as rain, sawdust, iron machining dust, and dust, and store the audio devices or other electric devices therein.

It is another object of the invention to provide an electric device mounting type tool storage having a power supply circuit device. The power supply circuit device can convert AC power into DC power and then use the DC power in the work site to which an AC power supply such as a commercial AC power supply and a generator is provided, and can use the accumulator battery having the same shape as a battery pack used in the electric tool as a power supply in the work site to which an AC power supply such as a commercial AC power supply and a generator cannot be provided.

The objects and other objects of the invention, and the characteristic and advantages of the invention will be more clearly understood from the following description in this specification and accompanying drawings.

According to a first aspect of the invention, a tool storage case, which has a storage case and a cover case provided at an opening of the storage case so as to open and close the opening, includes a tool storage portion for storing an electric tool body; a first electric device storage portion for storing an audio device; a battery storage portion for storing a battery pack; an audio device that is stored in the first electric device storage portion; a power cord that is stored in the storage case so as to be drawn outward from the storage case; inner wiring lines that are disposed in the storage case so as to electrically connect the power cord with audio device and so as to electrically connect the battery storage portion with the audio device; and a pair of speaker units that is mounted on a side wall of the storage case so as to be separated from each other and is driven by the audio device. In this case, each of the storage case and the cover case is partitioned into a pair of small chambers by a chamber partition wall protruding inward from the inner surface of each of the storage case and the cover case so as to correspond the pair of speaker units. Furthermore, when the cover case closes the storage case, an enclosure is formed.

According to another aspect of the invention, a tool storage case, which has a storage case and a cover case provided at an opening of the storage case so as to open and close the opening, includes a tool storage portion for storing an electric tool body; an electric device storage portion for storing an audio device; a pair of speaker units that is mounted on a side wall of the storage case so as to be separated from each other and is driven by the audio device; and dust blocking filters that are detachably mounted on the side walls, to which the pair of speaker units is fixed, so as to cover cone side surfaces of the speaker units, respectively. In this case, when the cover case closes the storage case, the tool storage forms an enclosure of the pair of speaker units.

According to a still another aspect of the invention, a tool storage case, which has a storage case and a cover case provided at an opening of the storage case so as to open and close the opening, includes a tool storage portion for storing an electric tool body; at least one electric device storage portion for storing an electric device; a battery storage portion for storing a battery pack; at least one electric device that is stored in the electric device storage portion; a power cord that is stored in the storage case so as to be drawn outward from the storage case; an AC-DC converter power supply circuit that is formed in the storage case and converts AC voltage supplied from the power cord into DC voltage; and a power switching circuit that is formed in the storage case, and selectively supplies one of DC power of the battery pack stored in the battery storage portion or AC-DC converter power to the electric device. In this case, inner wiring lines between the power cord and the AC-DC converter power supply circuit, and inner wiring lines among the power switching circuit, the AC-DC converter power supply circuit, the battery storage portion are disposed along the storage partition walls. Further, the partition walls along which the inner wiring lines are disposed are composed of a plurality of walls, and the inner wiring lines are disposed between the plurality of walls. Furthermore, openings of the partition walls are closed by elastic bodies.

According to further another aspect of the invention, the chamber partition walls are composed of a plurality of walls, and the plurality of walls is separated from each other so as to form a space therebetween.

According to still another aspect of the invention, the storage case or the cover case is provided with a packing made of elastic material so that the packing is interposed between the chamber partition walls protruding inward from the inner surfaces of the both cases in a close state in which the cover case closes the storage case.

According to another aspect of the invention, the above-mentioned tool storage case further includes speaker covers that are fixed to the side wall of the storage case so as to cover the rear surfaces of speaker units and have holes serving as sound channels, respectively; and speaker partition walls that partition storage portions for storing the speaker units and protrude inward from the inner surfaces of the storage case and the cover case. In this case, each of the speaker partition walls is provided perpendicular to the surface of the hole of the speaker cover, and holes is provided between the ends of the speaker partition walls, and the storage case or the cover case. That is, each the speaker partition walls includes a sound channel hole so as to form a maze sound channel with respect to the hole of the speaker cover.

According to still another aspect of the invention, the above-mentioned tool storage case further includes dust blocking filters that are detachably mounted on the front walls, to which the speaker units are fixed, so as to cover cone side surfaces of the speaker units, respectively.

According to further another aspect of the invention, the audio device includes a radio tuner and an audio amplifier.

According to another aspect of the invention, the audio device is formed in one casing as a unit, and the audio device unit is detachably stored in the storage case, and includes dry-cell batteries and a speaker therein so as to be independently operated when being separated from the storage case.

According to another aspect of the invention, the audio device includes operation switches and a displaying portion, which are more outward exposed to the outside than the outer surface of the side wall of the storage case. In addition, the operation switches and the displaying portion are provided in a recess of the side wall.

According to still another aspect of the invention, the power cord is composed of a winding type cord, which is wound by a helical spring so as to be stored in the tool storage case.

According to further another aspect of the invention, the inner wiring lines are disposed along one of the storage partition walls, the chamber partition walls, and speaker partition walls. Further, the partition walls along which the inner wiring lines are disposed are composed of a plurality of walls, and the inner wiring lines are disposed between the plurality of walls. In addition, openings of the partition walls are closed by elastic bodies.

According to another aspect of the invention, an engaging mechanism between the battery storage portion of the storage case and the battery pack is the same as that between the battery pack and the tool body.

According to another aspect of the invention, power of the battery pack engaged with the battery storage portion, or DC power converted from AC power supplied from the power cord is supplied to the audio device from a power switching circuit.

According to still another aspect of the invention, the storage case further includes a second electric device storage portion, and an MD player or a CD player is stored in the second electric device storage portion.

According to another aspect of the invention, the MD player or the CD player is held in the second electric device storage portion by a holding member of which length is adjusted so as to correspond to the size of the MD player or the CD player.

According to further another aspect of the invention, the operation switches of the audio device are covered with elastic dust-proof material.

According to still another aspect of the invention, the storage case further includes a third electric device storage portion, and a GPS unit is stored in the third electric device storage portion.

According to another aspect of the invention, the radio tuner includes an antenna, and the antenna is mounted in the tool storage case.

Since the electric tool and other electric devices, specifically audio devices, are stored in one storage case, the invention has one advantage to provide a compact electric device mounting type tool storage case that is convenient to be transported by a vehicle or to be carried and stores other electric devices, specifically an audio device therein. Specifically, the audio device such as a stereo is formed so as to be attached to and detached from the store case, and storage portions for storing an electric tool, a battery, a charger, a wrench and a nipper are provided in the sound channel space. Accordingly, it is possible to unite the tool case and the audio device such as a stereo having high sound quality without enlarging the size of the audio device. For this reason, it is not necessary to separately transport two packages of the tool storage case and the audio device, whereby it is possible to improve work efficiency and to reduce efforts.

The storage portion of the tool storage case for storing the electric tool body is partitioned into a plurality of chambers by the partition walls to form sound channels of a pair of speakers, and the tool storage case serves as a speaker enclosure. Accordingly, the invention has another advantage that it is possible to obtain fruity and high quality low-pitched tone. Specifically, since a double chamber partition wall is provided in the middle of the tool storage case to divide the space in the tool storage case into two sound channel spaces, it is possible to improve the separation degree of the sound from the right and left speakers of a stereo.

Specifically, according to the invention, since elastic members such as rubber are provided between the chamber partition walls of the storage case and the cover case in a close state in which the cover case closes the storage case, the sealing degree is improved. Therefore, sound quality is improved. In addition, since the rattle generated from a few gaps is also absorbed by rubber-like elastic members, it is possible to prevent the rattle from being generated.

The dust blocking filters that are detachably mounted on the side walls of the tool storage case, to which the pair of speaker units is fixed, so as to cover cone side surfaces of the speaker units, respectively, Accordingly, the invention has another advantage that it is possible to protect the speakers from the contaminated environment such as sawdust, iron machining dust, and dust. Furthermore, the space between the storage portion of the case and the sound channel space is not sealed in order to resonate vibration of the speakers in the sound channel space. According to the invention, the chamber partition walls (which include speaker partition walls) at which the space between the cover case and the storage case is not sealed are formed in the form of a maze, and sound passages are formed by means of the chamber partition walls or storage partition walls while objects to be stored such as the tool body is made not to collide with the speakers. Mesh members having breathability are provided to the passage in order to prevent the penetration of iron machining dust or wood machining dust. Accordingly, even though the tool or the like is stored in the storage portion serving as a sound channel, it is possible to prevent the speakers from being damaged.

The power supply circuit device is provided in the tool storage. The power supply circuit device can convert AC power into DC power and then use the DC power in the work site to which an AC power supply such as a commercial AC power supply and a generator is provided, and can use the accumulator battery having the same shape as a battery pack used in the electric tool as a power supply in the work site to which an AC power supply such as a commercial AC power supply and a generator cannot be provided. Accordingly, the invention has another advantage that it is possible to drive the audio device even in the work site to which an AC power supply is not provided. Therefore, it is possible to drive the audio device during the transportation of the tool body or work for a long time.

Since the switches are covered with rubber dust-proof material, the invention has another advantage to have a structure that prevents the cone surfaces of the speakers from being contaminated and has strong resistance against iron machining dust, dust, or rain.

Since an audio device unit (audio unit) smaller than the tool storage case is detachably stored in the tool storage case, the invention has still another advantage that it is possible to independently be used at a small place by separating only the audio device unit from the tool storage case.

Operation knobs or switches, a liquid crystal displaying portion, and the like are recessed from the outer surface of the side wall of the storage case. Accordingly, the invention has further another advantage to protect the operation knobs or switches, the liquid crystal displaying portion, and the like from the collision with obstacles.

Since the power cord is composed of a winding type cord, which is wound by a helical spring, the invention has further another advantage that the power cord is not held by obstacles and not obstructed when being stored in the tool storage case.

When the cover case the tool storage case is open, storage partition walls in which the inner wiring lines are disposed are formed by double walls so that the inner wiring lines in the tool storage case is not exposed. Then, the inner wiring lines are disposed between the double walls. Furthermore, the double walls are covered with an elastic member, such as rubber, serving as a lid. Accordingly, the invention has another advantage that the inner wiring lines are not exposed and thus can be protected from damages.

An engaging mechanism (latching mechanism) between the storage case and the battery pack is the same as the engaging mechanism of the battery pack for engaging the battery pack with the tool body. Accordingly, the invention has further another advantage that it is possible to prevent the separation or the poor contact of the battery during the transportation of the tool storage case.

The CD player or the MD player can be stored and fixed regardless of their sizes, and are used while being stored in the case. Therefore, the invention has still another advantage that it is most preferable to use the tool storage case in the work site generating much dust and impact.

Since the GPS unit is provided in the tool storage case, the invention has another advantage that it is possible to prevent the tool body and other electric devices from being thieved, and to confirm the unfamiliar current location.

Since an AM bar antenna and an FM rod antenna (or wire antenna) are provided in the tool storage case, the invention has further another advantage that they are not hindrances to the transportation and hardly damaged.

### BRIEF DESCRIPTION OF THE DRAWINGS

These and other objects and advantages of this invention will become more fully apparent from the following detailed description taken with the accompanying drawings in which:

FIG. 1 is a plan view showing a tool storage case according to a first embodiment of the invention;

FIG. 2 is a cross-sectional view of the tool storage case according to the invention taken along line A-A in FIG. 1;

FIG. 3 is a cross-sectional view of the tool storage case according to the invention taken along line B-B in FIG. 1;

FIG. 4 is a front view showing the tool storage case according to the invention shown in FIG. 1;

FIG. 5 is a circuit block diagram of an audio device to be mounted in the tool storage case according to the invention shown in FIG. 1;

FIG. 6 is a plan view showing a tool storage case according to a second embodiment of the invention;

FIG. 7 is a cross-sectional view of the tool storage case according to the invention taken along line A-A in FIG. 6;

FIG. 8 is a front perspective view showing a detachable audio device unit to be mounted in the tool storage case according to the invention shown in FIG. 6;

FIG. 9 is a rear perspective view showing the detachable audio device unit to be mounted in the tool storage case according to the invention shown in FIG. 6; and

FIG. 10 is a circuit block diagram of the audio device unit to be mounted in the tool storage case according to the invention shown in FIG. 6.

### DESCRIPTION OF THE EMBODIMENTS

Hereinafter, preferred embodiments of the invention will be described in detail with reference to drawings. In all drawings to be used to describe the embodiments, a member having the same function has the same reference numeral, and the repeated description thereof will be omitted.

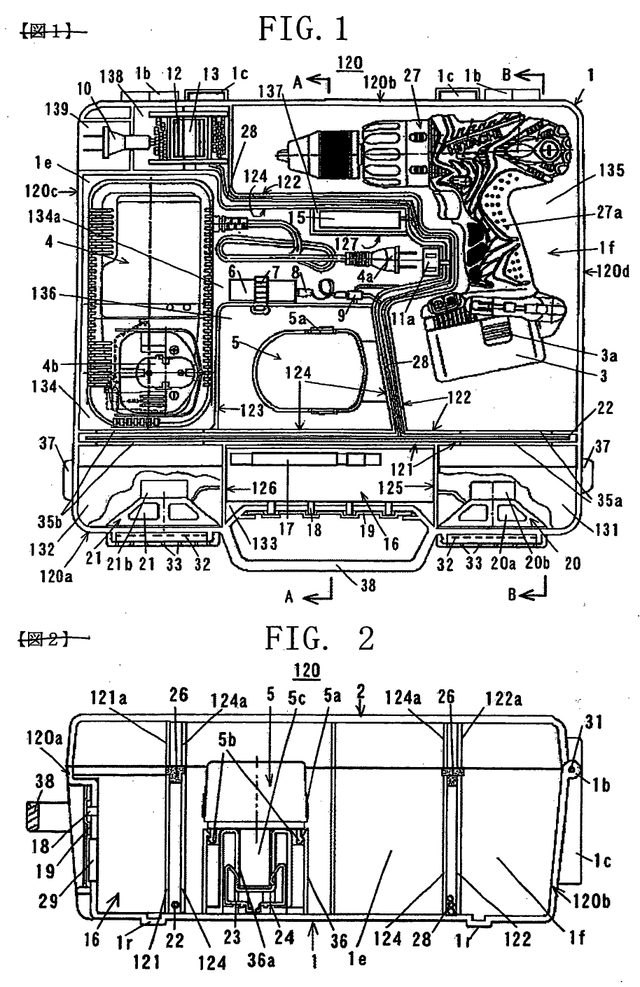

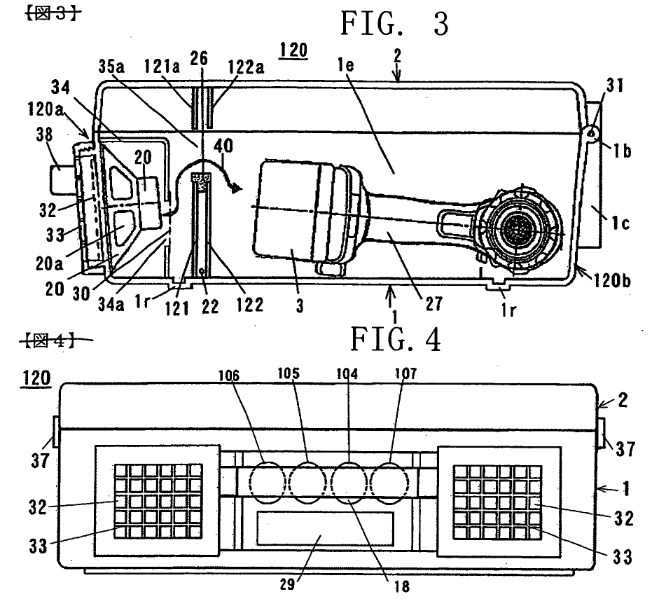

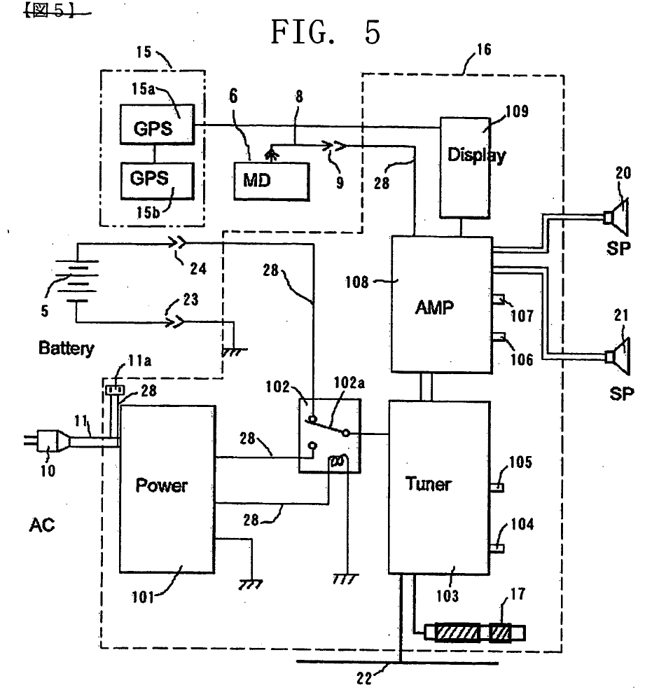

FIGS. 1 to 5 show a structure of an electric device mounting type tool storage case. In the electric device mounting type tool storage case, a driver drill body and the charger thereof are stored in a tool storage case for storing a cordless driver drill, and audio devices serving as another electric devices are mounted in the tool storage case. FIG. 1 is a plan view, FIG. 2 is a cross-sectional view taken along line A-A in FIG. 1, FIG. 3 is a cross-sectional view taken along line B-B in FIG. 1, FIG. 4 is a front view, and FIG. 5 is a circuit block diagram of the audio device.

Structure of Tool Storage Case and Speaker Enclosure

The tool storage case 120 according to the invention is composed of a storage case 1, and a cover case 2 which is provided so as to open and close the opening of the storage case 1. Each of the storage case and the cover case is injection molded in the shape of, for example, a box with synthetic resin material (plastic material). The box-shaped tool storage case 120 includes a front and a rear walls 120a and 120b, and a left and a right walls 120c and 120d. A handle 38 for transporting the tool storage case is integrally formed on the front wall 120a.

A cavity is formed in each of the storage case 1 and the cover case 2, which are divided into an upper part and a lower part. The storage case and the cover case are coupled with each other by means of hinge pins 31 (see FIGS. 2 and 3) to be inserted into hinge portions 1b so that the cover case can open and close the opening of the storage case (the cover case can be swung about the hinge portion). The storage case 1 and the cover case 2 are pivotally connected to each other by means of the hinge portions 1b so that the cover case can open and close the opening of the storage case and can be closed by latches (catches) 37. It is not necessary that both of the cases 1 and 2 be fixed by the hinge portions 1b so as to open and close with respect to each other. For example, the cover case 2 is separated from the storage case 1 in the open state, and is united with the storage case 1 only in the close state so that the storage case 1 and the cover case 2 may be sealed to each other by means of latch type or sliding type fasteners. As shown in FIG. 2, lower feet 1c are provided on the rear wall 120b of the tool storage case 120 (storage case 1), and a plurality of bottom feet 1r is provided on the bottom surface of the storage case. Accordingly, it is possible to stand or lay down the tool storage case 120.

Storage portions 131 to 139 are partitioned by partition walls (ribs) 121 to 127 in the storage case 1 of the tool storage case 120. That is, the storage case includes a tool storage portion 135 for storing a cordless driver drill (electric tool body) 27 which is detachably provided with a battery pack (cassette type accumulator battery) 3 and has a T shape in plan view, an electric device storage portion (first electric device storage portion) 133 for storing an audio device 16, a battery storage portion 136 for storing a spare battery pack (cassette type accumulator battery) 5, a charger storage portion 134 for storing a charger 4, an MD storage portion (second electric device storage portion) 134a for storing an MD player 6 available in the market, a GPS storage portion (third electric device storage portion) 137 for storing a GPS unit 15, a plug storage portion 139 for storing a plug 10, and a storage portion 138 for storing a power cord 11. In addition to the above-mentioned storage portions, the storage portions may include another storage portion for storing a wrench or a nipper. The partition walls 121 to 127 are injection molded so that they are integrally formed with the storage case 1 and protrude from the inner surface of the storage case. Partition walls 121a to 127a also protrude from the inner surface of the cover case 2 so as to correspond to the partition walls 121 to 127 (see FIGS. 2 and 3).

The upper and lower partition walls 121 to 127 and 121a to 127a extend so as to face each other, and includes long partition walls of which ends are close to each other, and short partition walls of which ends are not close to each other. For example, corresponding partition walls 122a and 124a of the cover case, which extend close to the partition walls 122 and 124 forming a double-wall shown in FIG. 2, and a packing 26 made of elastic material such as a strip-shaped rubber divide the space closed by the storage case 1 and the cover case 2 into two sound channel spaces 1e and 1f to be described below. Both partition walls 121a and 124a corresponding to each other also serve as chamber partition walls. Meanwhile, as shown in FIG. 3, the partition walls 121 and 122 extend so that the ends of the partition walls 121 and 122 stay away from corresponding partition walls 121a and 122a of the cover case. Accordingly, a gap (window) 35a is formed between the both partition walls. The gap 35a is provided to form a sound channel as described below.

A pair of speaker units 20 and 21 (hereinafter, the ‘speaker unit’ is simply referred to as a ‘speaker’) is mounted on the front wall 120a of the storage case 1. The speakers 20 and 21 are composed of dynamic cone type speakers, which have been widely used, and include speaker cone papers 20a and 21a having a diameter of, for example, about 10 cm, and magnets 20b and 21b for driving voice coils (not shown), respectively.

The pair of speakers 20 and 21 is covered with speaker covers 34 on the rear side thereof, respectively. Accordingly, it is possible to prevent iron machining dust and dust, which may be stuck in the contaminated environment of the work site, or rainwater from penetrating to the speaker magnets 20b and 21b or the cone papers 20a and 21a. That is, as shown in FIG. 3, a speaker cover 34, which is a member for covering the speaker from the outside, is provided between the right sound channel space 1e and the right speaker 20. The speaker cover 34 has a hole 34a. A mesh cloth formed in the mesh shape is attached to the hole 34a. In the vicinity of the hole, the height of the double chamber partition walls 121 and 122 is set to be about half of whole height of the tool storage case 120. In this case, since the chamber partition walls 121 and 122 of the storage case 1 do not come in close contact with the double partition walls 121a and 122a of the cover case 2, a gap 35a serving as a sound channel of 30 to 50 mm is formed. The gap 35a and the hole 34a are not aligned with each other in the thickness direction of the tool storage case 120 so as to form a maze structure. The same structure as described above is also provided in the case of the speaker 21. Vibration of the cone paper 20a of the speaker 20 is transmitted to the sound channel space 1e in the form of sound-flow 40 through a maze sound channel 1p. However, the cordless driver drill 27 (or charger 4) stored in the sound channel space 1e is separated and held by the maze and walls 121, 122, and 124. Accordingly, the speaker is protected from the collision with the tool. In addition, since the mesh cloth is provided, it is possible to prevent the machining dust stuck to the tool from penetrating to the speaker magnet or the cone paper. Furthermore, sound coming out from the rear surface of the cone paper 20a (or 21a) is transmitted to the sound channel space 1e in the form of sound-flow 40 through the maze sound channel 1p composed of the gap 35a and the hole 34a, and then resonates in the sound channel space 1e. Accordingly, high quality sound is played with high efficiency.

The sound channel spaces 1e and 1f are provided on the rear sides of the speakers 20 and 21, respectively, in order to increase sound volume by causing the audio from the speakers to resonate, and in order to also play the low-pitched tone. First, as shown in FIG. 3, the double chamber partition walls (speaker partition walls) 121 (121a) and 122 (122a) are provided on the rear side of the right speaker 20 disposed in a speaker storage portion 131 to partition the storage portion 135 for storing the tool body 27. The chamber partition walls have a gap (window) 35a, and the speaker storage portion 131 is communicated with the storage portion 135 for storing the tool body through the gap 35a to form one sound channel space 1f. In a similar way, the rear side of the left speaker 21 disposed in a speaker storage portion 132 is communicated with the charger storage portion 134 and the battery storage portion 136 through the gap (window) 35b to form the sound channel space 1e. That is, right speaker 20 is communicated with the sound channel space 1f, and the left speaker 21 is communicated with the sound channel space 1e. Both sound channel spaces 1f and 1e are separated or isolated from each other by the double chamber partition walls (122 and 124, 121 and 124) as described above. Accordingly, the sound channel spaces 1f and 1e are independently provided. Specifically, as described above, the double partition walls 122 and 124 are covered with the strip-shaped rubber packing 26 serving as a lid, and the strip-shaped rubber packing 26 has a size to be appropriately pressed by the double partition walls 122a and 124a of the cover case 2 when the cover case 2 is closed. Accordingly, the left sound channel space 1e and the right sound channel space 1f are more completely isolated from each other. For this reason, it is possible to more completely separate the stereo sound and then to play high quality sound. Moreover, since the rattle generated from a few gaps is also absorbed by rubber-like elastic material, it is possible to prevent the rattle from being generated. It is more effective that glass wool is interposed between the double partition walls.

According to the invention, when the storage case 1 and the cover case 2 are closed by the latches 37, both the storage case 1 and the cover case serve as a speaker enclosure for the pair of speakers 20 and 21. The sound channel spaces of the enclosure available in the market are generally formed in the shape of a cube. However, according to the invention, since the sound channel spaces have different shapes in order to receive the cordless driver drill 27, the charger 4, or the battery pack (cassette type accumulator battery) 5 therein with high efficiency and small spaces, it is possible to obtain the same effect as that in the related art.

Furthermore, according to the invention, since the tool body 27, the charger 4, and the battery pack 5 are stored in the sound channel spaces 1e and 1f of the tool storage case 120 when being transported, it is easy to transport the audio device 16 to be described below and the tool body 27 as one package. Accordingly, it is possible to improve transportation efficiency. In addition, if the audio device 16 to be described below is used in a state in which the tool body 27 and other electric devices 4 and 5 are removed from the tool storage case 120, it is possible to obtain a high sound quality audio device, which has satisfactory sound channel spaces and speakers (20, 21) mounted thereto. Of course, when the objects to be stored, such as the tool body and the like, are stored in the tool storage case, sound volume is reduced, whereby sound quality slightly deteriorates. However, it is possible to provide a practical tool storage case.

Dust blocking filters 32, which are made of non-woven fabric made of chemical fiber or thin plastic material, are detachably provided on the front sides of the speakers 20 and 21, respectively, so as to cover the front sides thereof, and grid covers (fitting members) 33, which are made of resin and have meshes (lattices) or slits, are detachably fitted on the front wall 120a. The grid covers may be fixed on the front wall 120a by screws. The dust blocking filters 32 prevent dust or iron dust in the construction site, or rainwater from being stuck to the cone papers 20a and 21a of the speakers 20 and 21. Specifically, even though iron machining dust occurring in the working site during the work is sucked into and stuck to the speaker magnets 20b and 21b, the grid covers 33 are separated from the front wall 120a and then the dust blocking filters 32 are replaced, thereby removing the iron machining dust. Since the grid covers 33 have large meshes or lattices, sound is not blocked. In addition, if the grid covers 33 are made of thin plastic plates, the cone papers 20a and 21a can be protected from rainwater and have a waterproof structure. Furthermore, the dust blocking filters 32 may be composed of two filter layers.

As shown in FIG. 1, an audio device 16 for driving the pair of speakers 20 and 21 is mounted in the storage portion 133 disposed between the storage portions 131 and 132 in which the pair of speakers 20 and 21 is separately stored. As shown in FIG. 5, the audio device 16 includes an AC-DC converter power supply circuit 101, a power switching circuit 102, a radio tuner circuit (FM front end circuit and AM front end circuit) 103, an audio amplifying circuit 108, and a display circuit 109. The radio tuner circuit 103 has an AM receiving bar antenna 17, and a FM receiving rod antenna or wire antenna 22. The audio amplifying circuit 108 amplifies audio signals demodulated by the radio tuner circuit 103 to drive the left and the right speakers 20 and 21. Furthermore, the audio amplifying circuit 108 may amplify signals received from an auxiliary external input terminal (AUX terminal) 9, and may amplify, for example, audio signals received from the MD player 6 that is stored in the MD storage portion 134a (see FIG. 1). Further, the audio amplifying circuit 108 may amplify audio signals received from the GPS unit 15, which includes a GPS (global positioning system) body circuit 15a and a GPS control circuit 15b. Each of the functional circuits constituting the audio devices 16 is composed of, for example, an integrated circuit that is formed in one package by means of a known integrated circuit technology. The audio device includes a plurality of integrated circuits 101, 102, 103, 108, and 109, which is mounted on one or more circuit boards by means of a known mounting technology together with other circuit elements. The audio device 16 is mounted in the storage portion 133 (see FIG. 1) of the storage case 1 in the form that the circuit boards are assembled in a casing. In addition, each of the circuit units of the audio device 16 may be provided with assembling portions that are used to assemble the circuit board in the storage case 1, and the storage case 1 may have the casing as a part thereof. It is also possible to constitute other electric devices 15 and 8 by means of circuit components, which are formed by a known integrated circuit technology. Moreover, an MD player available in the market may be used as the MD player 8.

In the embodiment shown in FIG. 1, the MD player 6 available in the market is mounted in the storage portion 134a of the storage case 1, and is fixed by a retaining band 7. If an elasticized rubber band is used as the retaining band 7, it is possible to fix MD players that have various sizes and are available in the market. Furthermore, since the MD player is mounted in the case not so as to move, the MD player can be played during the transportation of the case. A fabric belt capable of adjusting the length thereof may be used instead of the rubber band.

The MD player 6 is electrically connected to a jack 9 by a detachable signal line 8, and is electrically connected to the audio amplifying circuit 108 by inner wiring lines 28 to be described below. Accordingly, audio is played by the audio amplifying circuit 108 and the speakers 20 and 21.

As shown in FIG. 4, the display circuit 109 of the audio device 16 is electrically connected to a liquid crystal display 29, which is disposed on the front wall 120a of the storage case 1 so as to be exposed to the outer surface thereof, and drives the liquid crystal display 29. The liquid crystal display 29 displays mode switching information, information on the reception frequency of the radio tuner 103, clock time information, and the like.

In addition, the GPS unit 15 can display position information on the liquid crystal display 29. A map is not necessary to go to an unfamiliar work site by virtue of the location information displayed by the GPS unit 15, and it is possible to prevent the tool body from being thieved. As shown in FIG. 1, the GPS unit 15 is stored in the GPS storage portion 137, and is electrically connected to the liquid crystal display 29 of the audio device 16 by wiring lines 28 disposed between the double chamber partition walls 122 and 124 as described below.

The audio device 16 is provided with a main switch 106 for controlling a power supply to be turned on/off, a switch 104 that switches the tuner 103 into AM or FM mode and switches the auxiliary external input terminal (AUX terminal), a channel selecting switch 105 for selecting the channel of the tuner 103, and a volume switch 107 for adjusting the sound volume of the audio amplifying circuit 108. As shown in FIGS. 1 to 4, each of the switches is composed of a known push-button switch 18 on the front wall 120a of the audio device 16, and is covered with a rubber cover 19 made of sheet-shaped elastic material. The rubber cover 19 is attached by a double-sided tape, or is fixed to the storage case 1 by means of screws (not shown).

Since each of the switches is composed of a push-button switch, it is possible to easily prevent the penetration of dust or rainwater in the work site. Furthermore, it is possible to more reliably prevent the penetration of dust or water by the rubber cover. Each of the switches 104 to 107 is not limited to a push-button switch, and a known rotary switch may be used together with a waterproof element such as an O-ring, thereby preventing the penetration of dust or water.

In addition, the switches 18 (104 to 107) or the liquid crystal display 29 of a displaying portion are recessed from the front surface of the storage case 1 and the cover case 2, or the speakers 20 and 21 by 10 mm or more. Accordingly, when the tool storage case collides with an obstacle such as a timber during the transportation in the work site, the switches and the displaying portion hardly come in contact with the obstacle, thereby protecting the switches and the displaying portion from the damage.

As shown in FIG. 5, a commercial AC power supply to which power is fed through the plug 10, the power cord 11, and the inner wiring lines 28 to be described below, a DC power supply of the AC-DC converter power supply circuit 101 for converting the power generated by another AC power supply such as a generator into a DC power, or a DC power supply of the auxiliary battery pack (cassette type accumulator battery) 5 stored in the battery storage portion 136, is used as a power supply of the audio device 16. The above-mentioned power supplies feed power to the power switching circuit 102 through the inner wiring lines 28 stored in the storage case 1, and then are alternatively selected by the power switching circuit 102. Accordingly, the voltage of any one of the power supplies is used as an operating power for operating the circuit units 103, 108, and 109 of the audio device 16. Furthermore, the power may be used as an operating power for operating the MD player 6 and the GPS unit 15. In the embodiment shown in FIG. 5, if the plug 10 is connected to the AC power supply, the AC-DC converter power supply circuit 101 outputs DC voltage to the inner wiring lines 28 and automatically switches a relay switch 102a of the power switching circuit 102 from the battery pack 5 to the AC power supply. When the power consumption of the battery pack 5 is reduced or the AC power supply is used for a long time, the power switching circuit 102 is effective.

A battery pack having the same shape and charging/discharging capacity as those of the battery pack (cassette type accumulator battery) 3 set in the tool body (cordless driver drill) 27 is used as the auxiliary battery pack (cassette type accumulator battery) 5 for feeding DC power. For example, the battery pack is composed of a Nickel-Cadmium battery (Ni—Cd battery) or a Nickel-Hydrogen battery. The cassette type accumulator battery 5 is set or fixed in the storage portion 136, which is partitioned by single partition wall 123 and a double partition wall 124. The engaging mechanism between the battery storage portion 136 of the storage case and the battery pack 5 is the same as that between the battery pack 3 and the tool body (cordless driver drill) 27.

The engaging mechanism for fixing the battery pack 5 in the storage portion 136 is shown in the cross-sectional view of FIG. 2. That is, a battery bracket (holder) 36 is fixed in the storage case 1, and the bracket 36 includes a battery insertion hole 36a into which an insertion portion 5c having an oval cross-section of the battery pack 5 is inserted, and latch receiving portions 36b with which claws (hooks) 5b of latches 5a of the battery pack 5 are engaged. Wiring terminals 23 and 24 come in electrical contact with a positive electrode and a negative electrode by elastic forces thereof, respectively. The positive electrode and the negative electrode are exposed to the peripheral surfaces, which face each other, of the oval insertion portion 5c of the battery pack 5. Battery voltage is supplied to the automatic power switching circuit 102 shown in FIG. 5 through a pair of wiring lines 28 by the pair of wiring terminals 23 and 24. The engaging mechanism of the bracket 36 is the same as that between the battery pack 3 and the tool body (cordless driver drill) 27.

As described above, since the auxiliary battery pack 5 can feed a current into the tool storage case 120 by the latch mechanism mounted in the battery storage portion of the storage case 1, it is possible to play a stereo such as an audio device by using the battery pack as a power supply in the work site without AC power during the work or transportation. In this case, since the battery is fixed by the latch mechanism, it is possible to prevent the battery from being separated and to prevent the poor contact of the battery caused by vibration. In addition, if the latch mechanism has elastic members or ribs in the inside of the cover case facing the battery pack 5, it is possible to easily hole the auxiliary battery pack 5.

Meanwhile, as shown in FIG. 1, AC power is fed to the tool storage case 1 through the plug 10 and the power cord 11, and is converted into low DC voltage by the above-mentioned AC-DC converter power supply circuit 101 to be supplied to the audio device, the GPS unit and the like. As shown in FIG. 1, the plug 10 used to feed the AC power is stored in the plug storage portion 139 of the storage case 1, which is partially opened to the outside of the tool storage case 120, and the power cord 11 electrically connected to the plug 10 is stored in the cord storage portion 138, which is formed adjacent to the cord storage portion 138. The power cord 11 includes a known automatic winding mechanism. That is, the power cord is wound around a bobbin 13, and the power cord is automatically wounded around the bobbin by the rotation operation of the bobbin caused by a helical spring 12. When the AC power is not used, the plug 10 is stored in the plug storage portion 139. When the AC power is used, the power cord 11 can extend to have a length of about 2 m by drawing the plug 10. When the known automatic winding mechanism includes a locking mechanism, it is possible to retain the extending length of power cord.

Accordingly, since the power cord 11 to be drawn from the tool storage case 120 is automatically wound, the power cord does not needlessly protrude from the tool storage case during the transportation of the tool storage case. For this reason, it is possible to prevent the mechanism for retaining or holding the power cord from being damaged.

As shown in FIG. 1, an outlet 11a, which is used to directly feed AC power fed to the plug 10 to an electric device is provided in the storage case 1. For example, in a case in which AC power is fed to a plug 4a of the charger 4, if the plug 4a is connected with the outlet 11a in the vicinity of the storage portion for the plug 4a, AC power can be supplied to the charger 4. In this case, if the battery pack to be charged is inserted into a battery insertion portion (hole) 4b of the charger 4, and is fixed by the latch mechanism (not shown) without the separation of the charger 4 from the tool storage case 120, the battery pack can be used in the tool storage case 120. Accordingly, while it is possible to the charger 4, specifically terminals (not shown) of the bracket of the battery insertion portion 4b, from being contaminated with dust such as iron machining dust in the work site by means of the cover case 2, the battery pack can be charged.

The inner wiring lines including the power wiring lines in the tool storage case 120 are provided along the above-mentioned storage partition walls or chamber partition walls (122, 124, etc.). For example, the inner wiring lines 28, which extend from the end of the power cord 11 stored in the cord storage portion 138 to the AC-DC converter power supply circuit 101 stored in the audio device storage portion 133, are disposed between the pair of chamber partition walls 122 and 124 forming the double wall between the sound channel spaces 1e and 1f to be described above. As described above, the double chamber partition walls 122 and 124 are injection molded in the form of a rib so that they are integrally formed with the case body. Accordingly, the chamber partition walls 122 and 124 are arranged with a gap of about 10 mm therebetween. The inner wiring lines 28 of the AC power supply, the inner wiring lines 28 connected to the terminals 23 and 24 (see FIG. 2) of the bracket to which the auxiliary battery pack 5 is fixed by the latches, the inner wiring lines 28 of the MD player 6 stored in the storage portion 134a, the inner wiring lines 28 of the GPS unit 15 stored in the storage portion 137, and the like are disposed in the space between the pair of chamber partition walls arranged with a gap of about 10 mm therebetween. In addition, as described above and shown in FIG. 2, the double partition walls 122 and 124 are covered with the strip-shaped rubber packing 26 serving as a lid, and the strip-shaped rubber packing 26 has a size to be appropriately pressed by the double partition walls 122a and 124a of the cover case 2 when the cover case 2 is closed.

As described above, the inner wiring lines of the power supply or inner signal lines thereof are disposed between the double chamber partition walls or storage partition walls and are covered with the strip-shaped rubber packing 26. Accordingly, when the tool and the like is disposed in or taken out of the sound channel spaces (storage portions), the inner wiring lines is not damaged and it is possible to prevent the damage or disconnection of the inner wiring. Furthermore, as described above, since the strip-shaped rubber packing 26 is held between the cover case 2 and the storage case 1, the sound channel spaces are sealed and the separation of sound is not affected by the inner wiring lines 28.

As shown in FIG. 1 or 2, the above-mentioned FM antenna 22 made of a (wire-shaped) copper wire such as a feeder or a (rod-shaped) metal bar is stored between the double chamber partition walls 121 and 122, and the double chamber partition walls 121 and 124, which extend in the horizontally direction. The FM antenna 22 has a length of, for example, about 45 cm. Meanwhile, the AM bar antenna 17 is composed of a ferrite bar having a length, for example, in the range of 10 to 20 cm and a coil, and is mounted in a body of the audio device 16 stored in the storage portion 133. As described above, since the antenna is mounted in the tool storage case 120 by using the large space thereof, it is possible to prevent the damage of the antenna, which occurs due to the collision with obstacles and the bend of the antenna. Moreover, the inner space of the tool storage case is large. Accordingly, when the antenna is disposed in an L shape as well as a linear shape, it is possible to also reduce the directivity of the antenna.

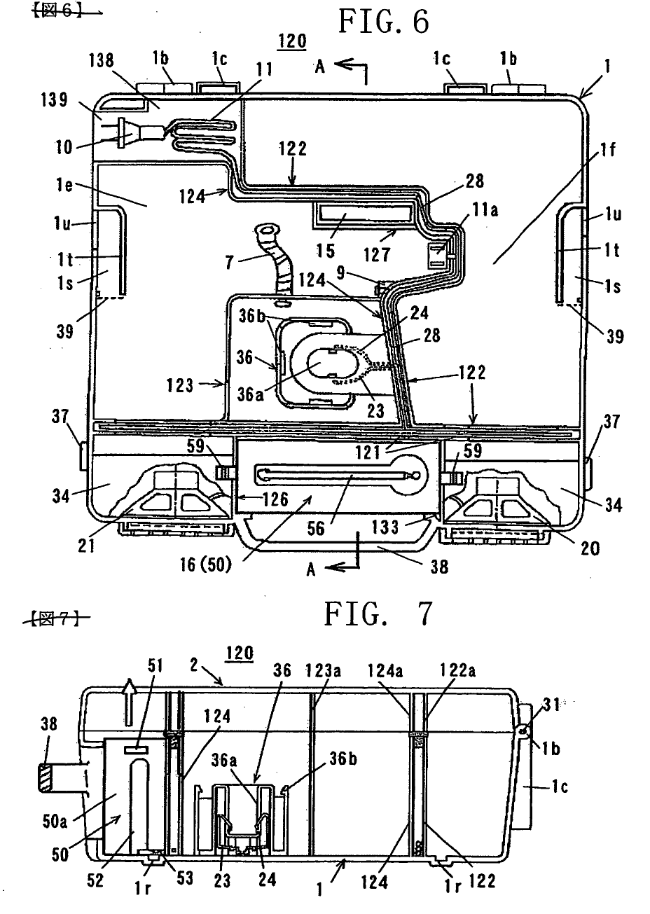

Each of FIGS. 6 to 10 is a view showing another embodiment of the invention. Specifically, FIG. 6 is a view showing a modification of the speaker enclosure.

The speaker enclosure of the speakers shown in FIG. 1 is generally known as a ‘closed speaker’ in which a left and a right sound channel spaces 1e and 1f are provided on the rear side of the speakers, respectively, and are sealed. Although the closed speaker has a relatively small sound volume, the closed speaker plays relatively high quality sound. In contrast, the modification shown in FIG. 6 is a speaker enclosure forming a bass reflex enclosure. The bass reflex enclosure has an effect that the play limit of the low-pitched tone is enlarged by using a small sound channel space. The bass reflex enclosure reflexes the low-pitched tone (bass) to use it. Accordingly, as shown in FIG. 6, a duct space 1s that is a volume for phase inversion is formed in each of a left sound channel space 1e and a right sound channel space 1f, and the tip opening 1u of the duct space 1s is opened to the outside of the tool storage case 120. Of course, the duct space 1s is formed to be continuous to the portion 2s (not shown) of cover case 2 facing the duct space as well as the storage case 1. Therefore, rib-shaped duct walls it of the storage case 1 are also continuous to corresponding rib-shaped duct walls 2t of the cover case 2. Volume of the duct spaces 1s and 2s defined by the rib-shaped duct walls 1t and 2t is determined depending on the frequency of the low-pitched tone to be played in consideration of speaker characteristic and sound channel volume. Duct openings 1u (the cover case 2 also has corresponding openings 2u) of the outlets of the sound channels is also designed similar to the above-mentioned structure. According to the bass reflex speaker enclosure, it is possible to play fruity and strong low-pitched tone.

In addition, the duct walls it provided in the storage case 1 can be used as partition walls for partitioning the storage portion, and the duct wall 1t provided in the right sound channel space 1f of the present modification can also serve as a holder of the handle 27a of the cordless driver drill 27. Accordingly, it is possible to prevent the objects to be stored from rattling. Furthermore, each of the duct walls 1t is composed of a thin rib, and thus is easily to be elastically deformed. Therefore, the duct walls can protect the case itself or body from the impact caused by falling.

Moreover, duct meshes 39 are fixed to the inlets of the duct spaces 1s (2s), respectively, by a known fixing method such as attaching or fitting. Accordingly, it is possible to prevent the foreign material from being penetrated into the duct spaces 1s and 2s, or to prevent the small objects to be stored from disappearing to the outside of the case.

Unlike the embodiment shown in FIG. 1, the power cord 11 stored in the cord storage portion 138 of the storage case 1 is not wound on the winding mechanism. Merely, the power cord is bent and stored in the storage portion 138. Even though a long power cord 11 is stored in the storage portion, it is possible to transport the tool storage case. In addition, if a lid (not shown) is provided at the opening of the plug storage portion, it is possible to prevent the plug 11 from falling during the transportation of the tool storage case.

Modification of Audio Device

As shown in FIGS. 6 to 10, an audio device 16 may has a so-called detachable structure. In the detachable structure, an assembly serving as an audio device unit (audio unit) 50 is provided in the casing 50a, which is separated from the storage case 1 and is smaller than the storage case 1. Then, when the audio device unit is detachably stored in the storage case 1, a power supply circuit and an output circuit of the audio device unit 50 are automatically and electrically connected to the inner wiring lines of the storage case 1.

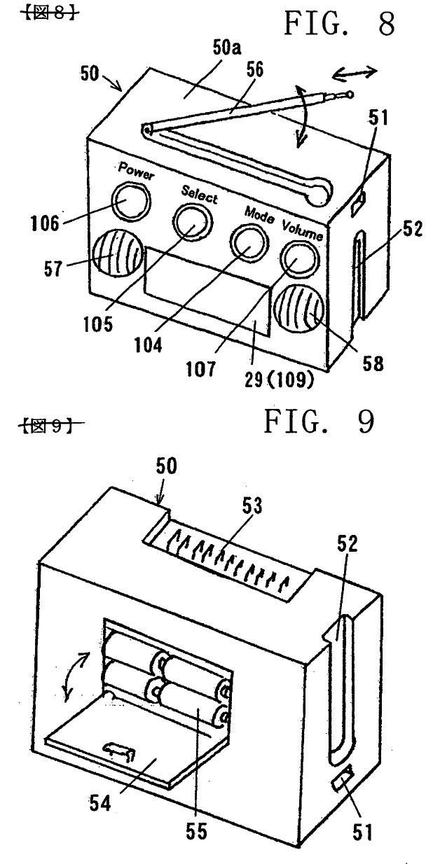

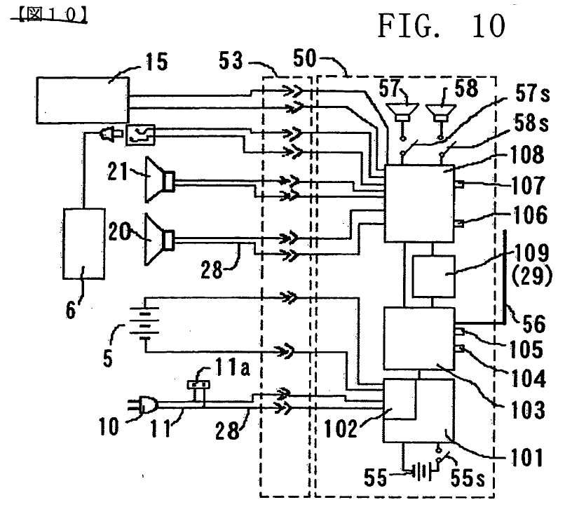

FIG. 8 is a perspective view showing the detachable audio device unit, and FIG. 10 is a circuit block diagram of the audio device unit. As shown in FIG. 8, the audio device unit 50 is assembled in the substantially cube-shaped casing 50a, which has a size capable of being stored in the storage portion 133 (see FIG. 6) of the storage case 1, and includes a main switch 106, a channel selecting switch 105, a mode switch 104, a volume switch 107, a display circuit 109, and a liquid crystal display 29. In addition, the audio device unit further includes a pair of small speakers 57 and 58 therein. Furthermore, as shown FIG. 9, dry-cell batteries 55 are provided in a dry-cell battery chamber to be closed by a dry-cell battery chamber cover 54 in order to independently operate the audio device unit 50 from the storage case 1. In addition, a FM receiving rod antenna 56 is rotatably mounted on the upper surface of the casing 50a. The casing 50a has positioning grooves 52 and engaging holes 51 on each of a left and a right side surfaces thereof. The positioning grooves and engaging holes are engaged with stoppers (not shown) fixed to the storage case 1 to position the casing.

As shown in FIG. 10, an inner circuit of the audio device unit 50 has the same structure as that in the first embodiment shown in FIG. 5. The audio device unit is different from the audio device of the first embodiment in the following aspect. An AC-DC converter power supply circuit 101 including a power switching circuit 102, a radio tuner circuit 103, an audio amplifying circuit 108, and a display circuit 109 including the liquid crystal display 29 are assembled in one casing 50a. Furthermore, since the pair of small speakers 57 and 58 and dry-cell batteries 55 are provided in the casing 50a, the audio device unit can serve as an independent audio unit when being separated from the storage case 1.

Accordingly, the casing 50a has an insert terminal row 53 (see FIG. 9) for electrically connecting the audio device unit with the inner circuit of the tool storage case. When the casing 50a is inserted into the storage portion 133 of the storage case 1, the audio device unit can be connected with the inner circuit (which include a connection circuit of big speakers 20 and 21, a connection circuit of an AC power cord 11, a connection circuit of the auxiliary battery pack 5, a connection circuit of the GPS unit 15, and a connection circuit of the MD player 6) of the storage case 1 through the terminal row 53. FIG. 7 illustrates a connection method between the audio device unit 50 and the storage case 1. In the method, the audio device unit is inserted into the storage case 1 from the upper side thereof, while each of the positioning grooves 52 is engaged with a stopper (not shown), for example a protrusion, fixed to the storage case 1. Accordingly, the audio device unit stops at a correct position in the case 1. In this case, the insert terminal row 53 is electrically connected with the corresponding terminal row (not shown) of the storage case 1. Simultaneously, speaker intermitting switches 57s and 58s (shown in FIG. 10) and a battery intermitting switch 55s are opened. Although not shown in FIG. 9, the speaker intermitting switches 57s and 58s and the battery intermitting switch 55s can be provided on the lower surface of the casing 50a. Each of them can be composed of a push-button (micro switch), and may be composed of an electromagnetic relay switch driven by a voltage fed from the battery pack 5 or an AC power plug 10. After the insertion of the audio device unit 50, stoppers 59 (see FIG. 6) of the storage case 1 are inserted into the engaging holes 51 (see FIG. 8) of the audio device unit 50, respectively so that audio device unit 50 is fixed and is not separated from the storage case. The audio device unit is guided by the positioning grooves 52, and thus the terminal row 53 can be connected with the terminal of the storage case. Accordingly, even though there are many connection terminals, the terminal row can be electrically connected with the terminal of the storage case with accuracy and stability. As described above, when the audio device unit 50 capable of being separated from the tool storage case is used, a tool storage case capable of storing an electric tool is used as a speaker enclosure in a case of a general work to play the high quality and fruity sound. Furthermore, for example, when the work is performed at a small place such as a roof, only the audio device unit (audio unit) 50 is separated from the tool storage case and is transported to the small place, whereby it is possible to play the audio device unit.

As clearly understood from the above description, according to the invention, it is possible to easily transport other electric devices such as an audio device in addition to the tool body, and to provide the tool storage case in which an electric device having contamination resistance against dust in the work site is assembled. Specifically, when the audio device as the electric device is assembled, it is possible to provide a tool storage case using itself as an enclosure of a pair of speakers. Furthermore, power wiring lines or mutual wiring lines for an electric device to be stored, for example an audio deice, are provided in the tool storage case, whereby it is possible to provide a tool storage case capable of operating the electric device, for example an audio device or a charger, in the tool storage case.

As described above, the invention has been described in detailed with reference to embodiments proposed by the inventor. However, the invention is not limited to the above-mentioned embodiments, and may have various modifications within the scope of the invention.

What is claimed is:

1. A tool storage case having a storage case and a cover case provided at an opening of the storage case so as to open and close the opening, said tool storage case comprising:
a tool storage portion for storing an electric tool body;
a first electric device storage portion for storing an audio device; and
a battery storage portion for storing a battery pack,
wherein said storage portions are partitioned by partition walls in the storage case of the tool storage case;
a power cord that is stored in the storage case so as to be drawn outward from the storage case;
a plurality of inner wiring lines that are disposed in the storage case so as to electrically connect the power cord with an audio device when stored in the first electric device storage portion and so as to electrically connect the battery storage portion with the audio device; and
a pair of speaker units that is mounted on a side wall of the storage case so as to be separated from each other and is driven by the audio device,
wherein each of the storage case and the cover case is partitioned into a pair of small chambers by a chamber partition wall protruding inward from the inner surface of each of the storage case and the cover case so as to correspond the pair of speaker units, and
wherein when the cover case closes the storage case, an enclosure is formed.

2. The tool storage case according to claim 1,
wherein the chamber partition walls are composed of a plurality of walls, and the plurality of walls is separated from each other so as to form a space therebetween.

3. The tool storage case according to claim 1,
wherein the storage case or the cover case is provided with a packing made of elastic material so that the packing is interposed between the chamber partition walls protruding inward from the inner surfaces of the both cases in a close state in which the cover case closes the storage case.

4. The tool storage case according to claim 1, further comprising:
a plurality of speaker covers that are fixed to the side wall of the storage case so as to cover the rear surfaces of speaker units and have holes serving as sound channels, respectively; and
a plurality of speaker partition walls that partition said storage portions for storing the speaker units and protrude inward from the inner surfaces of the storage case and the cover case,
wherein each of the speaker partition walls is provided perpendicular to the surface of the hole of the speaker cover, and
a plurality of holes provided between the ends of the speaker partition walls, and the storage case or the cover case.

5. The tool storage case according to claim 1, further comprising:
a plurality of dust blocking filters that are detachably mounted on the front walls, to which the speaker units are fixed, so as to cover cone side surfaces of the speaker units, respectively.

6. The tool storage case according to claim 1,
wherein the audio device includes a radio tuner and an audio amplifier.

7. The tool storage case according to claim 1,
wherein the audio device is formed in one casing as a unit, and
wherein the audio device unit is detachably stored in the storage case, and includes a battery and a speaker therein so as to be independently operated when being separated from the storage case.

8. The tool storage case according to claim 1,
wherein the audio device includes operation switches and a displaying portion which are more outward exposed to the outside than the outer surface of the side wall of the storage case, and
wherein the operation switches and the displaying portion are provided in a recess of the side wall.

9. The tool storage case according to claim 1,
wherein the power cord is composed of a winding type cord which is wound by a helical spring so as to be stored in the tool storage case.

10. The tool storage case according to claim 1,
wherein the inner wiring lines are disposed along one of the storage partition walls, the chamber partition walls, and speaker partition walls,
wherein the partition walls along which the inner wiring lines are disposed are composed of a plurality of walls, and the inner wiring lines are disposed between the plurality of walls, and
a plurality of openings of the partition walls are closed by elastic bodies.

11. The tool storage case according to claim 1,
wherein an engaging mechanism between the battery storage portion of the storage case and the battery pack is the same as that between the battery pack and the tool body.

12. The tool storage case according to claim 1,
wherein power of the battery pack engaged with the battery storage portion, or DC power converted from AC power supplied from the power cord is supplied to the audio device from a power switching circuit.

13. The tool storage case according to claim 1,
wherein the storage case further includes a second electric device storage portion, and an MD player or a CD player is stored in the second electric device storage portion.

14. The tool storage case according to claim 13,
wherein when the MD player or the CD player is stored in said second electric device storage portion, the MD storage or the CD player is held in the second electric device storage portion by a holding member of which length is adjusted so as to correspond to the size of the MD player or the CD player.

15. The tool storage case according to claim 8,
wherein the operation switches of the audio device, when stored in the first electric device storage portion, are covered with elastic dust-proof material.

16. The tool storage case according to claim 13,
wherein the storage case further includes a third electric device storage portion, and a GPS unit is stored in the third electric device storage portion.

17. The tool storage case according to claim 6,
wherein the radio tuner includes an antenna, and the antenna is mounted in the tool storage case, when the audio device is stored in the first device storage portion.

18. A tool storage case having a storage case and a cover case provided at an opening of the storage case so as to open and close the opening, said tool storage case comprising:
a plurality of electric device storage portions for storing an electric tool and an audio device that are partitioned by a storage portion wall in the storage case of the tool storage case;
a pair of speaker units that is mounted on a side wall of the storage case so as to be separated from each other and is driven by the audio device; and
a plurality of dust blocking filters that are detachably mounted on the side walls, to which the pair of speaker units is fixed, so as to cover cone side surfaces of the speaker units, respectively,
wherein when the cover case closes the storage case, the tool storage forms an enclosure of the pair of speaker units.

19. The tool storage case according to claim 18,
wherein the dust blocking filters are mounted by fitting members, which are formed in the shape of a mesh or slit, so as to cover cone side surfaces of the speaker units, respectively.

20. The tool storage case according to claim 18,
wherein each of the storage case and the cover case is partitioned into a pair of small chambers by a chamber partition wall protruding inward from the inner surface of each of the storage case and the cover case so as to correspond to the pair of speaker units.

21. The tool storage case according to claim 20,
wherein the chamber partition walls are composed of a plurality of walls, and the plurality of walls is separated from each other so as to form a space therebetween.

22. The tool storage case according to claim 21,
wherein the storage case or the cover case is provided with a packing made of elastic material so that the packing is interposed between the chamber partition walls protruding inward from the inner surfaces of the both cases in a close state in which the cover case closes the storage case.

23. The tool storage case according to claim 18, further comprising:
a plurality of speaker covers that are fixed to the side wall of the storage case so as to cover the rear surfaces of speaker units and have holes serving as sound channels, respectively; and
a plurality of speaker partition walls that partition storage portions for storing the speaker units and protrude inward from the inner surfaces of the storage case and the cover case,
wherein each of the speaker partition walls is provided perpendicular to the surface of the hole of the speaker cover, and
wherein a plurality of holes are provided between the ends of the speaker partition walls, and the storage case or the cover case.

24. A tool storage case having a storage case and a cover case provided at an opening of the storage case so as to open and close the opening, said tool storage case comprising:
a tool storage portion for storing an electric tool body;
at least one electric device storage portion for storing an electric device; and
a battery storage portion for storing a battery pack,
wherein said storage portions are partitioned by storage partition walls in the storage case of the tool storage case;
a power cord that is stored in the storage case so as to be drawn outward from the storage case;
an AC-DC converter power supply circuit that is formed in the storage case and converts AC voltage supplied from the power cord into DC voltage; and
a power switching circuit that is formed in the storage case, and selectively supplies one of DC power of the battery pack stored in the battery storage portion or AC-DC converter power to the electric device,
wherein inner wiring lines between the power cord and the AC-DC converter power supply circuit, and inner wiring lines among the power switching circuit, the AC-DC converter power supply circuit, the battery storage portion are disposed along the storage partition walls,
wherein the partition walls along which the inner wiring lines are disposed are composed of a plurality of walls, and the inner wiring lines are disposed between the plurality of walls, and
wherein a plurality of openings of the partition walls are closed by elastic bodies.

25. The tool storage case according to claim 24,
wherein when AC input voltage input from the power cord is supplied to the AC-DC converter power supply circuit, the power switching circuit automatically supplies the DC output voltage of the AC-DC converter power supply circuit to the electric device.

26. The tool storage case according to claim 24,
wherein an engaging mechanism between the battery storage portion of the storage case and the battery pack is the same as that between the battery pack and the tool body.

27. The tool storage case according to claim 24,
wherein the power cord is composed of a winding type cord, which is wound by a helical spring so as to be stored in the tool storage case.

28. The tool storage case according to claim 24,
wherein the storage case is provided with an outlet electrically connected to the power cord.

29. The tool storage case according to claim 24,
wherein the electric device is an audio device.

30. The tool storage case according to claim 29,
wherein the audio device includes a radio tuner and an audio amplifier.

31. The tool storage case according to claim 24,
wherein the storage case further includes a second electric device storage portion for storing a charger for charging the battery pack.

32. The tool storage case according to claim 31,
wherein the storage case further includes a third electric device storage portion for storing an MD player or a CD player.
